(19) United States
(12) Patent Application Publication
(10) Pub. No.: US 2015/0114239 A2
(43) Pub. Date: Apr. 30, 2015

(54) Caps For Fruits and Vegetables

(71) Applicant: Mark W. Levie, Ross, CA (US)

(72) Inventor: Mark W. Levie, Ross, CA (US)

(73) Assignee: Discovery, Inc., Ross, CA (US)

(21) Appl. No.: 14/204,798

(22) Filed: Mar. 11, 2014

Related U.S. Application Data
(60) Provisional application No. 61/790,535, filed on Mar. 15, 2012.

(51) Int. Cl. A23N 15/06

(52) U.S. Cl. CPC A23N 15/06
USPC 99/645

(57) ABSTRACT

A cover for a cut portion of a fruit or vegetable includes a fruit or vegetable engaging base surface, a raised boundary rim coupled to the base surface, and at least one spike emanating from the base surface. In another embodiment, a cover for covering a cut portion of food includes a base having an outer perimeter and a food engaging surface, and a food penetrating member extending outwardly from the food engaging surface.

### FIELD

The present invention concerns caps or covers for positioning on cut surfaces of fruits and vegetables in order to cover any exposed edges thereof.

### BACKGROUND

Consumers often will cut a piece of fruit or a vegetable and consume only part of the fruit or vegetable. For example, a consumer may cut several slices from a cucumber, but a portion of the cucumber may be unused. The consumer then has to figure out a way to store the cut cucumber in their refrigerator for later use. Consumers will often place the cucumber in a resealable zipper storage bag, or will wrap a piece of plastic wrap around the cucumber. This can result in a waste of resources that could be avoided if a reusable covering could be employed. Consumers may alternatively place the cucumber in a sealed reusable container. However, fruits and vegetables respirate and emit ethylene gas as they ripen. By enclosing vegetables in a container or bag, the ethylene gas is trapped inside the package, which speeds up the ripening, and hence, spoiling process. Alternatively, if only the end of the fruit is covered, the air within the refrigerator will be recirculated and the ethylene that is emitted will be less likely to cause premature ripening and spoiling. A reusable cover for fruits and vegetables is needed.

### BRIEF DESCRIPTION OF THE DRAWINGS

FIG. 1a is a top plan view of an example cap for use with a fruit or vegetable, such as a lemon;

FIG. 1b is a perspective top view of the example cap of FIG. 1;

FIG. 1c is a side view of the example cap of FIG. 1a;

FIG. 1d is a cross-sectional side view of the example cap of FIG. 1a taken along line A-A;

FIG. 1e is a perspective side view of the example cap of FIG. 1a;

FIG. 1f is a rear view of the example cap of FIG. 1a depicting artwork that may be applied to the surface in order to represent what type of fruit or vegetable may preferably be used with the cap;

FIG. 2a is a top plan view of an alternative example cap for use with a fruit or vegetable, such as a tomato;

FIG. 2b is a perspective top view of the example cap of FIG. 2a;

FIG. 2c is a side view of the example cap of FIG. 2a;

FIG. 2d is a cross-sectional side view of the example cap of FIG. 2a taken along line A-A;

FIG. 2e is a perspective side view of the example cap of FIG. 2a;

FIG. 2f is a rear view of the example cap of FIG. 2a depicting artwork that may be applied to the surface in order to represent what type of fruit or vegetable may preferably be used with the cap;

FIG. 3a is a top plan view of an alternative example cap for use with a fruit or vegetable, such as an apple;

FIG. 3b is a perspective top view of the example cap of FIG. 3a;

FIG. 3c is a side view of the example cap of FIG. 3a;

FIG. 3d is a cross-sectional side view of the example cap of FIG. 3a taken along line A-A;

FIG. 3e is a perspective side view of the example cap of FIG. 3a;

FIG. 3f is a rear view of the example cap of FIG. 3a depicting artwork that may be applied to the surface in order to represent what type of fruit or vegetable may preferably be used with the cap;

FIG. 4a is a top plan view of an alternative example cap for use with a fruit or vegetable, such as an onion;

FIG. 4b is a perspective top view of the example cap of FIG. 4a;

FIG. 4c is a side view of the example cap of FIG. 4a;

FIG. 4d is a cross-sectional side view of the example cap of FIG. 4a taken along line A-A;

FIG. 4e is a perspective side view of the example cap of FIG. 4a;

FIG. 4f is a rear view of the example cap of FIG. 4a depicting artwork that may be applied to the surface in order to represent what type of fruit or vegetable may preferably be used with the cap;

FIG. 5a is a top plan view of an alternative example cap for use with a fruit or vegetable, such as a lime or a cucumber;

FIG. 5b is a perspective top view of the example cap of FIG. 5a;

FIG. 5c is a side view of the example cap of FIG. 5a;

FIG. 5d is a cross-sectional side view of the example cap of FIG. 5a taken along line A-A;

FIG. 5e is a perspective side view of the example cap of FIG. 5a;

FIG. 5f is a rear view of the example cap of FIG. 5a depicting artwork that may be applied to the surface in order to represent what type of fruit or vegetable may preferably be used with the cap;

FIG. 6a is a perspective side view of an example cap, such as that shown in FIG. 5a that has a different color based upon the type of fruit or vegetable it is ideally designed for;

FIG. 6b is a rear view of an example cap similar to that in FIG. 5a, depicting artwork that may be applied to the surface in order to represent what type of fruit or vegetable may preferably be used with the cap, such as a cucumber in the case depicted;

FIG. 7a is a rear plan view of an example cap depicting artwork for an orange;

FIG. 7b is a rear plan view of an example cap depicting artwork for an onion;

FIG. 7c is a rear plan view of an example cap depicting artwork for a tomato;

FIG. 7d is a rear plan view of an example cap depicting artwork for a squash or cucumber;

FIG. 7e is a rear plan view of an example cap depicting artwork for an avocado;

FIG. 7f is a rear plan view of an example cap depicting artwork for a melon, such as a cantaloupe.

FIG. 7g is a rear plan view of an example cap depicting artwork for an apple; and

FIG. 7h is a rear plan view of an example cap depicting artwork for a banana.

### DETAILED DESCRIPTION

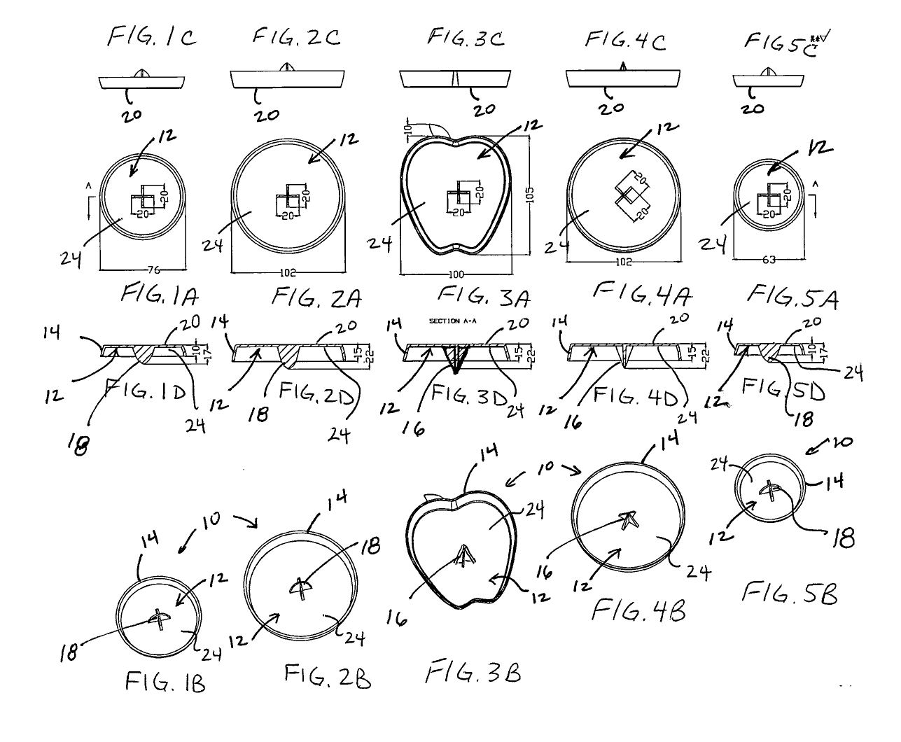

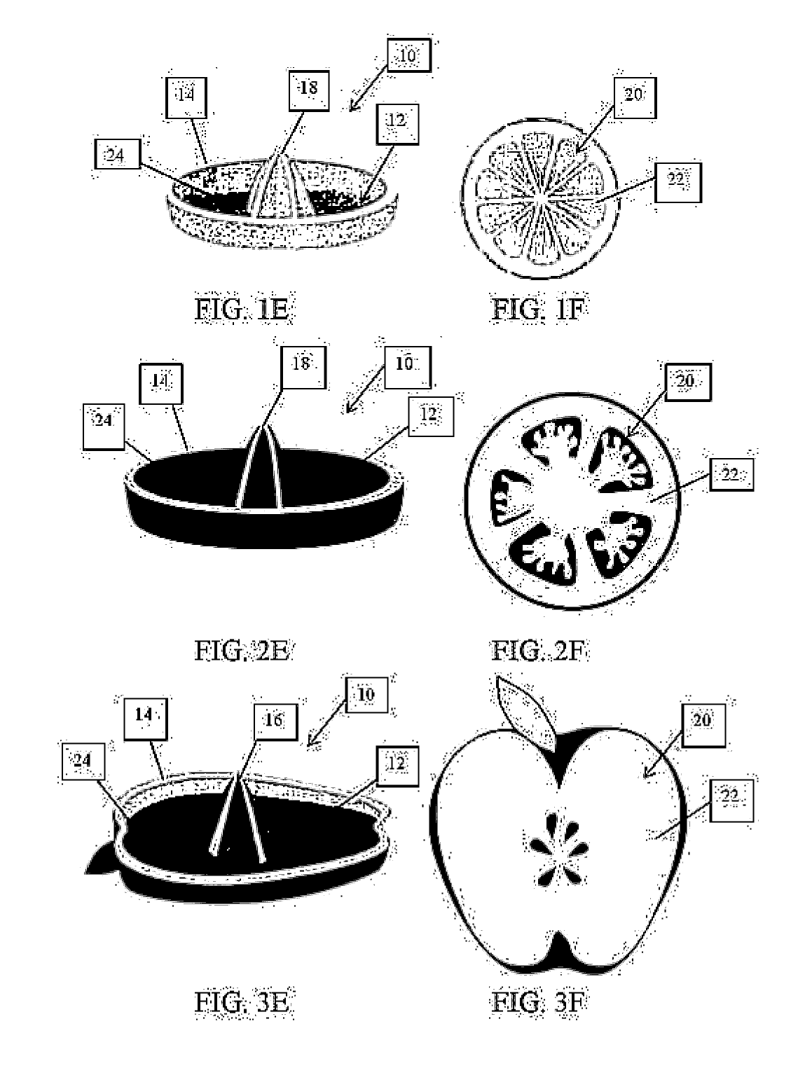

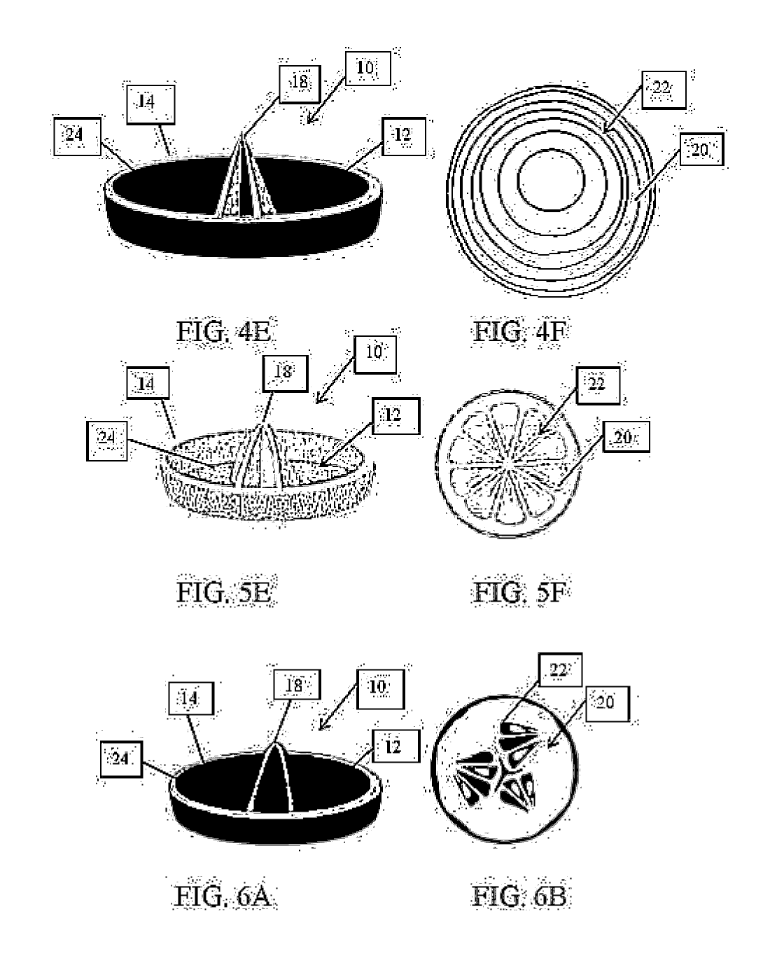

FIGS. 1-7 depict several different embodiments of a vegetable or fruit cap 10. The term cap is used herein interchangeably with the term cover, with both terms having the same meaning. FIGS. 1A-1F and FIGS. 6A-6B depict a cap 10 that is designed for use with a lime or a cucumber. FIGS. 2A-2F depict a cap 10 that is designed for use with a tomato. FIGS. 3A-3F depict a cap 10 that is designed for use with an apple. FIGS. 4A-4F depict a cap 10 that is designed for use with an onion. FIGS. 5A-5F depict a cap 10 that is designed for use with a lemon. The caps are substantially sized to match the shape of the fruit or vegetable that they are designed to fit on. While not all fruits and vegetables of the same type have exactly the same size, an average size and/or maximum size is used for each of the designs so that the cap 10 will fit most vegetables of the type that they are designed to fit on. This size may be determined by taking an average size based upon the particular fruit or vegetable as sold in the United States, among other ways to size the caps.

The caps are preferably made of plastic, such as polystyrene or polypropylene, and are rigid, although they could be made of silicone or a similar flexible material. The caps may have artwork on a rear side thereof that depicts the type of fruit or vegetable that the cap 10 is designed for use with. In addition, the caps may have a color that is consistent with the type of fruit or vegetable that the cap 10 is designed for use with. The caps are reusable and may be dishwasher safe. If desired, the cap does not need to include artwork representative of the type of fruit or vegetable. In addition, the cap does not have to have a color that is associated with a particular fruit or vegetable.

Each cap 10 includes a base 12 that has a fruit or vegetable engaging surface 24. The base may be flat in order to closely engage the surface of a cut piece of fruit or vegetable. A lip or rim 14 is positioned around an outer periphery of the base 12 and extends outwardly from the fruit engaging surface 24 either in a perpendicular or angled manner The rim 14 is designed to mate with a periphery of a fruit or vegetable if the fruit or vegetable is large enough. A spike 16, 18 extends from a substantially centrally located portion of the base 12 in the same direction as the rim 14.

Different types of spikes may be used. For example, in the case of harder fruits and vegetables, such as apples and onions, a pointed spike 16 may be used, such as that shown in FIGS. 3B, 3E, 4B and 4E. In other embodiments, the spike 18 may be more rounded and gentle for use with fruits and vegetables that are not as firm as an apple or onion. Examples of this type of spike 18 are shown in FIGS. 1B, 1E, 2B, 2E, 5B, 5E, 6A. The spike may be modified as necessary in order to ensure that the cap 10 will remain on the fruit or vegetable when applied. For example, the spike may be taller or shorter or wider or narrower. More than one spike may be used. For example, if the fruit is large, such as a cantaloupe or watermelon or pineapple, more than one spike may be used to help to maintain the cap 10 on the fruit or vegetable. In the case of hollow fruits, multiple spikes 16, 18 may be positioned near the outer periphery of the base 12. In some cases the spike may not be needed where the outer edge of the cap 10 closely matches the outer shape of the fruit or vegetable. The invention described herein covers embodiments that do not utilize a spike.

The front surface 24 of the cap 10 is the surface that seats against the fruit. The rear surface 20 is the side that faces away from the surface of the fruit. The rear surface 20 may be flat, rounded, raised, or any other shape, as desired. The rear surface 20 may have a profile or be flat. As previously discussed, the rear surface 20 may have artwork 22. In addition, the exterior surfaces of the cap may have a surface treatment that resembles the fruit that they are designed to be used with, as shown best in FIGS. 1E and 5E. For example, in FIGS. 1E and 5E, the outer surface of the cap has a surface treatment of small divots or another surface treatment that represents the surface of a lemon or lime. Alternatively, the rear surface may be plain or may have indicia on it.

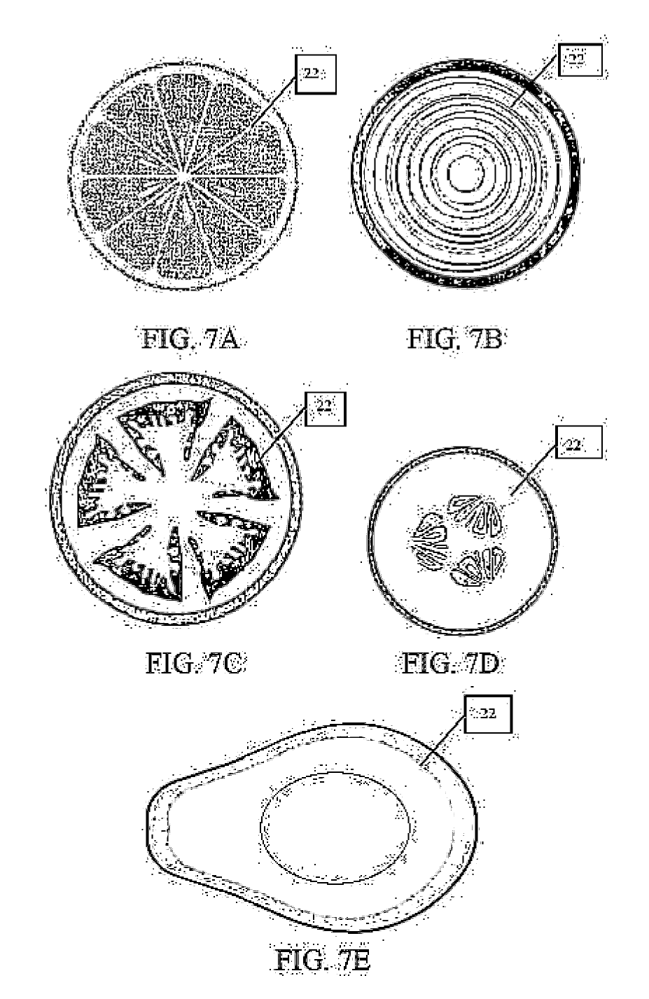

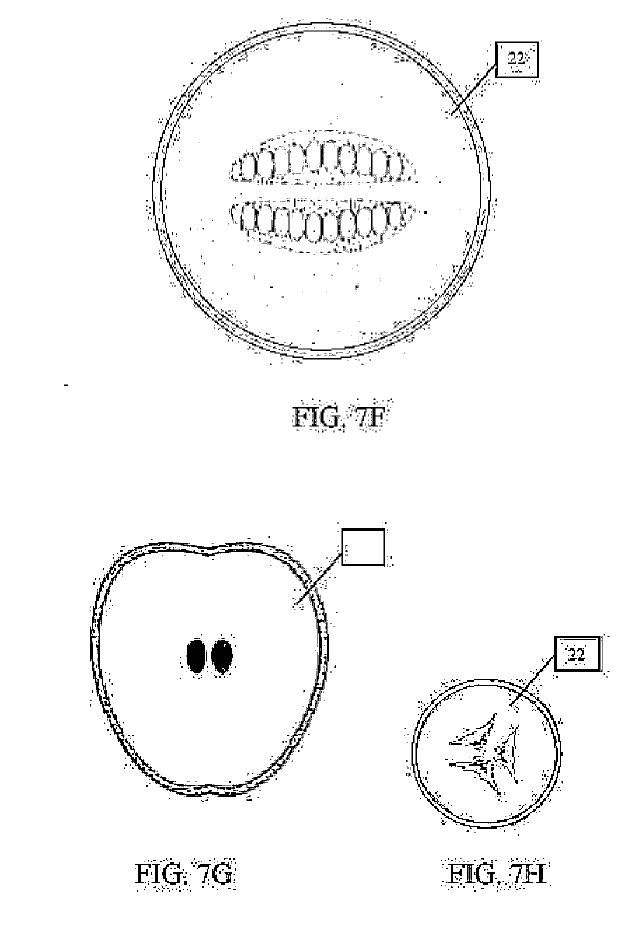

FIGS. 7A-7H depict alternative types of fruits or vegetables for which the cap may be designed. FIG. 7A depicts artwork 22 for a lemon or orange. FIG. 7B depicts artwork 22 for an onion. FIG. 7C depicts artwork 22 for a tomato. FIG. 7D depicts artwork 22 for a squash or cucumber. FIG. 7E depicts artwork 22 for an avocado. FIG. 7F depicts artwork 22 for a melon, such as a cantaloupe. FIG. 7G depicts artwork for an apple. FIG. 7H depicts artwork for a banana.

The various caps may have different dimensions depending upon the type of fruit or vegetable they are designed for. The lemon cap 10 shown in FIGS. 1A-1F may be round and have a diameter of about 2.75 to 3 inches and a rim 14 height of about 0.4 inches. The spike 18 may be about 0.6 inches tall and about 0.8 inches wide at the base of the spike 18. The rim 14 may have a thickness of about 2 mm.

The tomato cap 10 shown in FIGS. 2A-2F may be round and have a diameter of about 3.75 to 4 inches and a rim 14 height of about 0.6 inches. The spike 18 may be about 0.8 inches tall and about 0.8 inches wide at the base of the spike 18. The rim 14 may have a thickness of about 2 mm.

The apple cap 10 shown in FIGS. 3A-3F may resemble the outer shape of an apple and may have a length of about 3.75 to 4 inches and a rim 14 height of about 0.6 inches. The spike 16 may be about 0.8 inches tall and about 0.8 inches wide at the base of the spike 16. The rim 14 may have a thickness of about 2 mm.

The onion cap 10 shown in FIGS. 4A-4F may be round and have a diameter of about 3.75 to 4 inches and a rim 14 height of about 0.6 inches. The spike 16 may be about 0.6 inches tall and about 0.8 inches wide at the base of the spike 16. The rim 14 may have a thickness of about 2 mm.

The lime cap 10 shown in FIGS. 5A-5F may be round and have a diameter of about 2.25 to 2.5 inches and a rim 14 height of about 0.4 inches. The spike 18 may be about 0.6 inches tall and about 0.8 inches wide at the base of the spike 18. The rim 14 may have a thickness of about 2 mm.

The cucumber cap 10 shown in FIGS. 6A-6B may be round and have a diameter of about 2.25 to 2.5 inches and a rim 14 height of about 0.4 inches. The spike 18 may be about 0.6 inches tall and about 0.8 inches wide at the base of the spike 18. The rim 14 may have a thickness of about 2 mm.

The orange cap shown in FIG. 7A may be round and have a diameter of about 3.5 inches. The avocado cap shown in FIG. 7E may have an oblong, oval-like shape and have a width of about 3 inches and a length of about 4.5 inches. The banana cap shown in FIG. 7H may be round and have a diameter of about 2 inches. The cantaloupe cap shown in FIG. 7F may be round or oval and may have a diameter of about 7 inches. Different dimensions may alternatively be used, as desired.

Embodiments are envisioned where no outer rim is provided. The rim 14 may have a first height for a first fruit or vegetable and a second height for a second fruit or vegetable. For example, a smaller fruit or vegetable cap 10 may have a shorter rim 14 than a larger fruit or vegetable cap 10. The rim 14 may be perpendicular to the base 12, or may be angled slightly outwardly relative to the perpendicular. While the base 12 is shown as being flat on the fruit engaging surface 24, it could have a different shape.

In an alternative embodiment (not shown), the cap 10 could have two fruit engaging surfaces 24 for mating with a piece of fruit or vegetable on opposite sides of the base 12. In this alternative embodiment, the cap 10 may have a spike emanating from both the front and rear surfaces and a raised outer edge or rim may be provided around the outer periphery of the front surface 24 while another raised outer edge is provided on the opposite, rear surface. For the raised outer edge on the rear side, the raised outer edge or rim may be spaced inwardly from the outer periphery of the rear surface such that the cap 10 may be used with different sized pieces of fruit or vegetables.

According to one embodiment, a cover for a cut portion of a fruit or vegetable includes a fruit or vegetable engaging base surface, a raised boundary rim coupled to the base surface, and at least one spike emanating from the base surface. The base surface may be substantially planar. The cover may also include artwork provided on a surface opposite the fruit or vegetable engaging base surface that identifies to a consumer what type of product the cover is designed for use with.

The at least one spike may be rounded or pointed. The raised boundary rim may be coupled to an outer perimeter of the base surface. The rim may extend substantially perpendicular to the base surface or may be angled relative to the base surface. The spike and the rim may extend outwardly from the base surface in substantially the same direction. The rim may extend from the base surface in one direction and the opposite side of the base surface may be smooth.

According to another embodiment, a cover for covering a cut portion of food includes a base having an outer perimeter and a food engaging surface and a food penetrating member extending outwardly from the food engaging surface. The base may have the food engaging surface on a front side thereof, and the base may have a rear surface on the rear side thereof. The food engaging surface may be substantially planar and the rear surface may be substantially planar.

The cover may include a lip coupled to the base. The lip may extend substantially perpendicular to the food engaging surface or may be angled relative to the food engaging surface. The lip may be positioned around the outer perimeter of the base. The lip may be a rim and the rim may have a height for engaging a cut edge of a piece of food. The rim may have a surface treatment applied to an external surface thereof that resembles a type of food that the cover is designed for. The cover may have a color that resembles a type of food that the cover is designed for use with. The cover may be made of a rigid or a flexible polymeric material. Artwork may be applied to the rear surface of the cover, the artwork resembling a type of food that the cover is designed for. The food penetrating member may be a single spike or a plurality of spikes. When the food penetrating member is a plurality of spikes, the spikes may be spaced out around an outer perimeter area of the food engaging surface.

The terms “substantially” or “substantial,” or “generally”, as used herein, are terms of estimation.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A cover for a cut portion of a fruit or vegetable comprising:
a fruit or vegetable engaging base portion having a substantially planar base surface for abutting a cut edge of a portion of a fruit or vegetable;
a raised boundary rim coupled to the base surface and extending therefrom for engaging a side of the fruit or vegetable.

2. The cover of claim 1, wherein the base surface is substantially planar and further comprising at least one spike emanating from the base surface in a direction that is the same as the raised boundary rim.

3. The cover of claim 1, further comprising artwork or a color associated with a surface opposite the engaging base surface that identifies to a consumer what type of product the cover is designed for use with.

4. The cover of claim 2, wherein the at least one spike is one of rounded or pointed.

5. The cover of claim 1, wherein the raised boundary rim is coupled to an outer perimeter of the base portion.

6. The cover of claim 1, wherein the rim extends substantially perpendicular to the base surface or is angled relative to the base surface.

7. (canceled)

8. The cover of claim 1, wherein the rim extends from the base surface in one direction and the opposite side of the base surface is substantially smooth.

9. A cover for covering a cut portion of food comprising:
a base having an outer perimeter and a food engaging surface; and
a food penetrating member extending outwardly from the food engaging surface.

10. The cover of claim 9, wherein the base has the food engaging surface on a front side thereof, and the base has a rear surface on the rear side thereof.

11. The cover of claim 9, wherein the food engaging surface is substantially planar and the rear surface is substantially planar.

12. The cover of claim 9, further comprising a lip coupled to the base.

13. The cover of claim 12, wherein the lip extends substantially perpendicular to the food engaging surface or is angled relative to the food engaging surface.

14. The cover of claim 12, wherein the lip is positioned around the outer perimeter of the base.

15. The cover of claim 12, wherein the lip is a rim and the rim has a height for engaging a piece of food.

16. The cover of claim 15, wherein the rim has a surface treatment applied to an external surface thereof that resembles a type of food that the cover is designed for.

17. The cover of claim 9, wherein the cover has a color that resembles a type of food that the cover is designed for use with; and
the cover is made of a rigid or a flexible polymeric material.

18. The cover of claim 10, wherein artwork is applied to the rear surface of the cover, the artwork resembling a type of food that the cover is designed for.

19. The cover of claim 10, wherein the food penetrating member is a single spike or a plurality of spikes, and when the food penetrating member is a plurality of spikes, the spikes are spaced out around an outer perimeter area of the food engaging surface.

20. (canceled)

21. The cover of claim 1, wherein the raised boundary rim is flexible or stiff.

22. The cover of claim 1, wherein the base portion and raised boundary rim are made of one or more of silicone, polystyrene, or polypropylene.
